(19) United States
(12) Patent Application Publication
(10) Pub. No.: US 2024/0356969 A1
(43) Pub. Date: Oct. 24, 2024

(54) STATISTICAL MODELING OF EMAIL SENDERS TO DETECT BUSINESS EMAIL COMPROMISE

(71) Applicant: Cisco Technology, Inc., San Jose, CA (US)

(72) Inventors: Jan Brabec, Praha (CZ); Milos Lenoch, Praha (CZ); Tomas Sixta, Praha (CZ); Filip Srajer, Hradec Kralove (CZ); Radek Starosta, Praha (CZ)

(21) Appl. No.: 18/220,065

(22) Filed: Jul. 10, 2023

Related U.S. Application Data
(60) Provisional application No. 63/461,415, filed on Apr. 24, 2023.

(51) Int. Cl. H04L 9/40; G06Q 10/107

(52) U.S. Cl. CPC H04L 63/1483; G06Q 10/107

(57) ABSTRACT

Techniques for an email-security system to screen emails, extract information from the emails, analyze the extracted information, assign probability scores to the emails, and classify the email as suspicious or not. A method is disclosed that includes analyzing an email and extracting a first sender attribute and a second sender attribute from the email. Identifying one or more sender-specific models associated with a sending device, and applying one or more sender-specific models to determine a first probability value associated with the first sender attribute that conveys a likelihood that the first sender attribute is a misused sender attribute. Applying one or more sender-specific models to determine a second probability value associated with the second sender attribute is a second misused sender attribute, and determining, by using the first probability value and the second probability value, an overall probability value associated with a likelihood that the email is suspicious or not.

### RELATED APPLICATIONS

This application claims priority to Provisional Patent Application No. 63/461,415, filed on Apr. 24, 2023, the entire contents of which are incorporated herein by reference.

### TECHNICAL FIELD

The present disclosure relates generally to techniques for an email-security system to detect email-based impersonation attacks.

### BACKGROUND

Electronic mail, or “email,” continues to be a primary method of exchanging messages between users of electronic devices. Many email service providers have emerged that provide users with a variety of email platforms to facilitate the communication of emails via email servers that accept, forward, deliver, and store messages for the users. Email continues to be a fundamental method of communication between users of electronic devices as email provides users with a cheap, fast, accessible, efficient, and effective way to transmit all kinds of electronic data. Email is well established as a means of day-to-day, private communication for business communications, marketing communications, social communications, educational communications, and many other types of communications.

Business Email Compromise (BEC) can be viewed as an instrument analogous to an attack vector, where the goal of the attacker is to gain the trust of a victim and to manipulate the receiver to perform an unauthorized action with potential business-critical consequences (provide credentials, grant access, send money) via email. In some instances, the email may be configured without a link or an attachment, which makes the detection of the BEC much more challenging. An exemplary strategy to gain a receiver's trust the attackers is often to impersonate an employee (CEO, accountant) or a department (support, IT) of the targeted company. Such impersonation can be difficult to detect when analyzing emails individually, without understanding the broader context of the email. Current solutions, such as spoofing detection or using an active directory, are often ineffective against well-crafted attacks. Also, common anti-spam and anti-phishing techniques do not work very well, because the structure of BEC emails is often quite different from spam and phishing emails. Business Email Compromise (BEC) is an attack vector, where the goal of the attacker is to gain the trust of a victim and get them to perform an unauthorized action with potential business-critical consequences (provide credentials, grant access, send money) via email. The email does not need to contain a link or an attachment, which makes detection much more challenging.

One typical strategy of the attackers is to impersonate an employee (CEO, accountant) or a department (support, IT) of the targeted company. Such impersonation is very difficult to detect when analyzing emails individually, without a broader context. Current solutions, such as spoofing detection or using an active directory, are often ineffective against well-crafted attacks. Also, common anti-spam and anti-phishing techniques do not work very well, because the structure of BEC emails is often quite different from spam and phishing emails.

It is desirable to develop a process and system using information from prior communications of users to build individual-specific models of different sender email characteristics (such as their signatures) to determine one or more signals that allow for identifying suspicious or authentic emails.

It is desirable to develop a process and system for detecting contextual sender email behavior using a plethora of signals associated with the sender's email to determine deviations from a sender's typical behavior and to intercept or provide alerts of the likelihood that an email is an impersonation or fraud without there being any one particular signal that can be relied upon.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an example email-security system that implements the cognitive anti-phishing engine (CAPE) that detects assigns a probability score and generates a sender email model/profile to determine the likelihood that an email is suspicious or not.

FIG. 2 illustrates an example diagram of a framework for a cognitive anti-phishing engine (CAPE) in a system with sender-specific models to determine the likelihood that an email is suspicious or not.

FIG. 3 illustrates an example diagram of an email signal detector of a misused attribute in an email and an update of counts of attributes in an email to determine the likelihood that an email is suspicious or not.

FIG. 4 illustrates one or more attributes that are extracted from an email for use in sender-specific models to determine if an email is suspicious or not.

FIG. 5 illustrates a probability algorithm associated with a signature misuse detector to determine the likelihood that an attribute associated with a sender's signature indicates that an email is suspicious or not.

FIG. 6 illustrates a flow diagram of an example method for an email-security system to implement the CAPE that detects using a sender-specific model, the misuse of one or more attributes of an email to determine a probability score indicative of the likelihood that an email is suspicious or not.

FIG. 7 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes a detector using a sender-specific model for email-based impersonation attacks. The detector works by building a customer-specific statistical model of email senders. It can detect situations, where the adversary impersonates the victim's colleagues or professional contacts.

This disclosure describes techniques for an email-security system to detect email-based impersonation attacks using sender-specific email profiles that enable aggregating multiple signals associated with a sender email, and assign probability scores to the emails that indicate the likelihood of the emails being at least fraudulent impersonations. A method to perform the techniques described herein includes analyzing an email routed or sent from a sending device to a recipient email address at a receiving device. The method includes aggregating a series of vectors associated with the email by as an example, extracting a first sender attribute and a second sender attribute from the email. Identifying one or more sender-specific models associated with the sender's email address to create a context associated with the sender's email to aggregate multiple signals associated with the sender's email to determine if the sender's behavior is suspicious. The method may then apply one or more sender-specific models to determine multiple probability values associated with the email attributes. For example, applying one or more sender-specific models to determine if the first sender attribute conveys a likelihood that the first sender attribute is misused, and applying one or more sender-specific models to determine a second probability value associated with determining if the second sender attribute is a second misused sender attribute. Once each probability is determined, an overall probability is determined that is associated with a likelihood of classifying the email either as a suspicious email or an authentic email. In addition, a database of sender-specific models is asynchronously updated with data extracted from the sender's email for enhancing the sender-specific models used in the detecting process of the suspicious behavior associated with the sender.

Additionally, the techniques described herein may be performed by a system and/or device having non-transitory computer-readable media storing computer-executable instructions that, when executed by one or more processors, performs the method described above.

### Example Embodiments

This disclosure describes techniques for an email-security system to determine that an email is suspicious or authentic by aggregating a set of vectors associated with the email to determine from the email, the sender's behavior and the content of the email. Since there may not be any single signal indicative that the email is compromised, the email security system applies a dynamic detect-based set of detectors for each email with context by modeling email senders using a framework composed of a Cognitive Anti-Phishing Engine (CAPE). Each sender model is configured to implement a set of different detectors that include misuse signature detectors whose results are aggregated and classified to generate a verdict as the whether the email is compromised.

In embodiments, the email-security system may assign sender models composed of probability scores to emails that indicate the likelihood of the emails being compromised, or fraudulent impersonations of brands. The email security system may analyze the information contained within the emails for users and identify compromised or fraudulent emails by analyzing metadata and/or contents of the emails using a set of detectors composed of sender-specific models that include rule-based analysis, recognition analysis, probabilistic analysis, machine learning (ML) models, and so forth. The email security system may then assign the screened emails probability scores indicative of fraud, based at least in part on the extracted and analyzed information. The email security system may then classify the screened emails as fraudulent or not, based at least in part on the assigned probability score based on contextual behavior. The assigned probability score may be compared to a predetermined threshold value that is indicative of a high likelihood of a compromised, fraudulent impersonation, or authentic email of the sender or brand. In this way, the email security system can classify emails as compromised, fraudulent or authentic and prevent potential malicious attacks on users.

Thus, the email security system may monitor emails communicated between users of email platforms, email domains, corporate or internal email systems, or services to detect scam emails, phishing emails, and/or other malicious emails. The email security system may screen emails for monitoring and extracting information for analysis. The email security system may extract meaningful metadata from emails to determine whether the emails are scam emails or otherwise malicious. Meaningful metadata may include, for example, “From-Field” addresses (i.e., sender addresses), sender domain, displayed text, sender signature, brand names for the email, “URL” addresses contained within the email, “Reply-To Field” addresses and/or brand names of the email, a Date/Time the email was communicated, attachments and/or hashes of attachments to the email, URLs in the body of the email and/or associated with unsubscribe actions, and so forth. In some instances, the metadata may additionally include content included in the body of the email, actual attachments to the email, and/or other data of the email that may be private or confidential. Further, the metadata extracted from the email may generally be any probative information for the email security platform to determine whether an email is potentially compromised, suspicious, malicious, or authentic.

The email security system may be configured to identify scam emails, which are often designed to impersonate legitimate brands and are sent from attackers to facilitate the scam. For instance, an initial email may be sent from the attacker that includes a request for the target user to perform an action based on the type of scam. For instance, the initial email may request a gift card code, may request a wire transfer, may request a paycheck be deposited into a different bank account, a list of unpaid invoices, W-2 details of employee(s), sensitive information of clients, and so forth. Accordingly, impersonation (e.g., fraudulent) emails may need to be processed to determine the legitimacy of the email.

Proposed herein is an approach to enriching content-based detectors running on individual emails with context by modeling email senders.

Initially, an email arriving in a pipeline is taken and the system extracts attributes that are relevant for sender modeling. Some attributes, such as sender address, sender domain, or display text, are straightforward to extract. Others, such as the sender signature or email closing, can be extracted from email content using natural language processing. The attributes are next used in two branches. The first branch of the pipeline features the Database Updater component, which asynchronously updates the sender models in the database. It can do so efficiently by batching and aggregating the updates. The approach doesn't require the persistence of emails. The second branch represents the synchronous runtime, which operates on emails in real time. The runtime queries the database to retrieve observation counts and computes probabilities.

The email security system may be configured to process one or more probability scores to determine a final probability score. The determination of the final probability score may be by making one or more probability scores equally weighted or assigning them differing weights to factor together and determine the final probability score. The final probability score may then be assigned a classification that indicates that the emails are scam emails or otherwise malicious. As such, the classification may be based upon exceeding a predetermined threshold value. For example, the predetermined threshold value may be assigned to a threshold probability value of 0.75. As such, the final probability score exceeding the threshold probability score may render the classification of a fraudulent or suspicious email to the processed email.

The system can threshold the probabilities to find rare senders, rare sender domains, or impersonation of sender name and signature. Based on confidence in the decision, the detection can be used to support content detections, show warnings to the recipient or even block the message.

The sender modeling system includes a database that may keep statistics globally, per customer, and recipient. Contextualizing content detectors, such as knowing that the sender is unusual for the recipient's company, is critical, especially in BEC tasks where there are often no malicious signals present in content alone. In addition, the same data is used to filter benign traffic, as the system can detect frequent senders.

The fraudulent emails are quarantined, and the email security system may prevent any further communication received from the sender and/or further communication sharing similarities with the fraudulently classified, screened email.

The email security system may implement various additional remedial actions. The remedial actions may include harvesting the attacker's information for additional detection rules, blocking the fraudulent email, reporting the attacker's information to authorities, and so forth.

While the systems and techniques described herein are generally applicable for any type of malicious, impersonation email, fraudulent emails (often BEC attacks) are prominent threats that may be detected and mitigated according to the techniques described herein. BEC fraudulent emails include various types or classes, such as wire-transfer scams, gift card scams, payroll scams, invoice scams, acquisition scams, aging report scams, phone scams, a W-2 scam class, an aging report scam class, a merger and acquisition scam class, an executive forgery scam class, an attorney scam class, a tax client scam, an initial lure or rapport scam class, and so forth. In some instances, fraudulent attacks result in an organization or person under attack losing money or other financial resources. Additionally, the organization or person under attack may lose valuable information, such as trade secrets or other information. These types of fraud are often multi-stage attacks. Often, in the first stage, the attacker sends a fake email to the victim who is usually a manager or employee in the organization. This fake email may impersonate a real person who is also a legitimate employee of an organization to build a rapport and an official tone to the message. The fake email may accordingly or impersonate a brand and the email itself may be of a sophisticated construction including real domains and/or hyperlinks directed to the actual brand in an attempt to legitimize the email while requesting an action directed to a fraudulent domain and/or hyperlink. Once the victim succumbs to the fraud and follows the instructions found in the fraudulent email, the victim then transfers money to the attacker, either in the form of a transfer to a bank account or sending gift card credentials to an email address.

The term “brand,” as used and alluded to herein may be interchangeable with the term “organization,” “legitimate business,” and the like. Brand may also mean an “enterprise,” “collaboration,” “government,” “agencies,”, “corporate entity”, “any type of organization of people,” an “entity representative of some grouping of people,” etc. Furthermore, a brand may also represent an intangible marketing and/or business concept that helps individuals identify the legitimacy of the brand, company, individual, collaboration and the like by which the brand is associated.

Some of the techniques described herein are with reference to fraudulent emails. However, the techniques are generally applicable to any type of malicious email. As described herein, the term “malicious” may be applied to data, actions, attackers, entities, emails, etc., and the term “malicious” may generally correspond to spam, phishing, spoofing, malware, viruses, and/or any other type of data, entities, or actions that may be considered or viewed as unwanted, negative, harmful, etc., for a recipient and/or destination email address associated with email communication.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

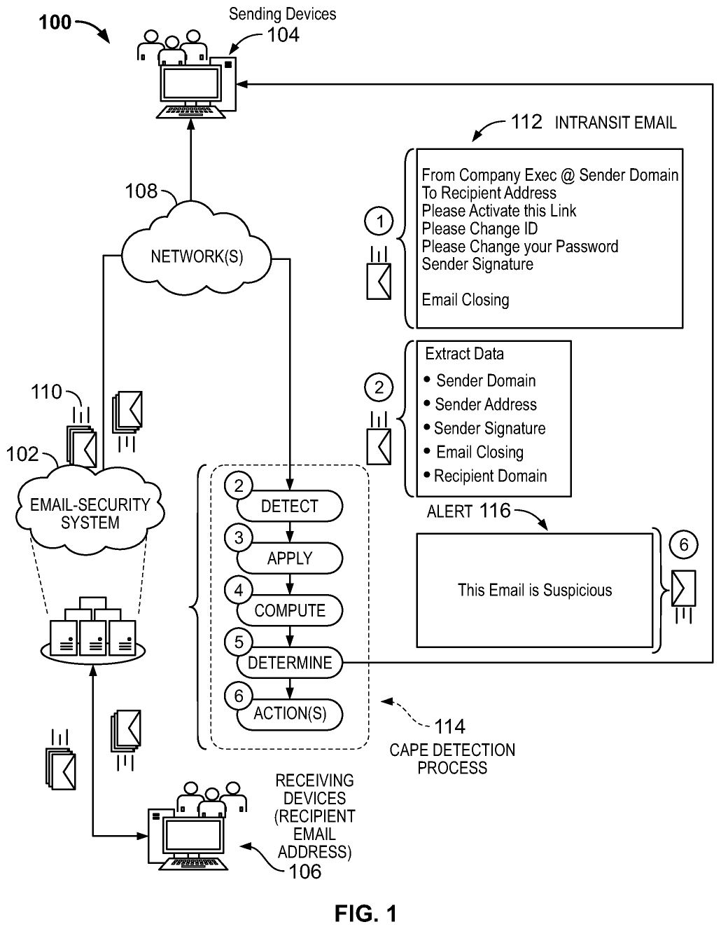

FIG. 1 illustrates a system-architecture diagram 100 of an example email-security system 102 that applies a set of user-specific profiles to detect email attributes and assign a probability score and classify an email indicating a likelihood of a fraudulent email.

In some instances, the email-security system 102 may be a scalable service that includes and/or runs on devices housed or located in one or more data centers, that may be located at different physical locations. In some examples, the email-security system 102 may be included in an email platform and/or associated with a secure email gateway platform. The email-security system 102 and the email platform may be supported by networks of devices in a public cloud computing platform, a private/enterprise computing platform, and/or any combination thereof. One or more data centers may be physical facilities or buildings located across geographic areas that are designated to store networked devices that are part of and/or support the email-security system 102. The data centers may include various networking devices, as well as redundant or backup components and infrastructure for power supply, data communications connections, environmental controls, and various security devices. In some examples, the data centers may include one or more virtual data centers which are a pool or collection of cloud infrastructure resources specifically designed for enterprise needs, and/or for cloud-based service provider needs. Generally, the data centers (physical and/or virtual) may provide basic resources such as processor (CPU), memory (RAM), storage (disk), and networking (bandwidth).

The email-security system 102 may be associated with an email service platform and may generally comprise any type of email service provided by any provider, including public email service providers (e.g., GOOGLE® Gmail, MICROSOFT® Outlook, YAHOO!® Mail, AOL mail, APPLE® mail, PROTON® mail, etc.), as well as private email service platforms maintained and/or operated by a private entity or enterprise. Further, the email service platform may comprise cloud-based email service platforms (e.g., Google G Suite, Microsoft Office 365, etc.) that host email services. However, the email service platform may generally comprise any type of platform for managing the communication of email communications between clients or users. The email service platform may generally comprise a delivery engine behind email communications and include the requisite software and hardware for delivering email communications between users. For instance, an entity may operate and maintain the software and/or hardware of the email service platform to allow users to send and receive emails, store and review emails in inboxes, manage and segment contact lists, build email templates, manage and modify inboxes and folders, scheduling, and/or any other operations performed using email service platforms.

The email-security system 102 may be included in, or associated with, the email service platform. For instance, the email-security system 102 may provide security analysis for emails communicated by the email service platform (e.g., as a secure email gateway). Furthermore, a second computing infrastructure may comprise a different domain and/or pool of resources used to host the email service platform.

The email service platform may provide one or more email services to users of user devices to enable the user devices to communicate emails. Sending devices 104 may communicate with receiving devices 106 over one or more networks 108, such as the Internet. However, the network(s) 108 may generally comprise one or more networks implemented by any viable communication technology, such as wired and/or wireless modalities and/or technologies. The network(s) 108 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network(s) 108 may include devices, virtual resources, or other nodes that relay packets from one device to another.

As illustrated, the user devices may include the sending devices 104 that send emails and the receiving devices 106 that receive the emails. The sending devices 104 and receiving devices 106 may comprise any type of electronic device capable of communicating using email communications. For instance, devices 104/106 may include one or more different personal user devices, such as desktop computers, laptop computers, phones, tablets, wearable devices, entertainment devices such as televisions, and/or any other type of computing device. Thus, the user devices 104/106 may utilize the email service platform to communicate using emails based on email address domain name systems according to techniques known in the art.

The email service platform may receive emails that are destined for the receiving device 106 that have access to inboxes associated with destination email addresses managed by, or provided by the email service platform. That is, emails, including allowed emails 110, are communicated over the network(s) 108 to one or more recipient servers of the email service platform, and the email service platform determines which registered user the email is intended for based on email information such as “To,” “Cc,” Bcc,” and the like. In instances where a user of the receiving device 106 has registered for use of the email-security system 102, an organization managing the user devices 104/106 has registered for use of the email-security system 102, and/or the email service platform itself has registered for use of the email-security system 102, the email service platform may provide the appropriate emails to the front end for pre-preprocessing of the security analysis process.

Generally, the email-security system 102 may perform at least metadata extraction techniques on the emails and may further perform content pre-classification techniques on the emails in some instances using various natural language techniques to extract attributes of the email 112. The types of metadata that may be scanned for, and extracted by, the email-security system 102 from an email 112 (i.e., an intercepted or in transit email on route to a recipient email address) includes indications of the “Reply-To Field” email address(es), the “From-Field” email address(es), the “Image” information of the emails, the “Subject” of the emails, the Date/Time associated with communication of the emails, indications of universal resource locator (URL) or other links in the emails, attachment files, hashes of attachments, fuzzy hashes extracted from the message body of the emails, content from the body of the email, etc. Generally, the email service platform and/or users of the email security platform may define what information is permitted to be scanned and/or extracted from the emails, and what information is too private or confidential and is not permitted to be scanned and/or extracted from the emails.

Upon extracting metadata (or “features”) from the emails that are to be used for security analysis, the email-security system 102 may perform security analysis on the email metadata using, among other techniques, security policies defined for the email security platform.

The email-security system 102 receives an email 112 and only extracts attributes that are relevant to probability modeling by user-specific models of attribute misuse by the cognitive anti-phishing engine (CAPE) 114. Some of the attributes associated with the metadata (i.e., metadata fields) include the sender address, sender domain (i.e., brand data), and displayed text. The email security system 102 includes the cognitive anti-phishing engine (CAPE) 114 that applies one or more user-specific models to determine probabilities for detected signals of misused attributes contained in an intercepted email 112. The CAPE 114 implements a series of functions to (1) receive the email, (2) detect the email attributes, (3) apply one or more user-specific models to determine a probability of a signal of a context or suspicious behavior from one or more email attributes extracted from an email, (4) compute a value of one or more probabilities associated with each signal of a misuse of an attribute using a sender specific model of the probability computation and then aggregating the value of each sender specific computed probability to determine an overall probability value, and (5) based on a threshold associated with the overall probability value, determine whether the likelihood that the email is suspicious or not, and (6) if the email is suspicious applying an appropriate action, or if the email is determined not suspicious (i.e., authenticate) then also applying an appropriate action.

In some embodiments, the CAPE 114 computes probability scores using one or more user-specific models associated with one or more sets of attributes to determine or classify email 112 based on the threshold likeliness of whether or not the email 112 is suspicious or authentic. The probability scores are summed or aggregated and compared to various threshold values to make the determination based in part on the sender's behavior and the context of the email whether the email is suspicious or not. Classification of the screened email 112 as fraudulent may be achieved by comparing the probability score (e.g., “Final Probability Score”) to a predetermined threshold value. In some instances, the predetermined threshold value may be assigned to a value of 0.75. In such instances, a probability score exceeding the threshold value may result in a classification of the email as fraudulent. As such, classification (action (6)) as fraudulent may ensure that email 112 is not sent to the receiving device 106 on which the victim is reading emails, and an alert 116 may be generated and associated with email 112. In some embodiments, email 112 may be blocked

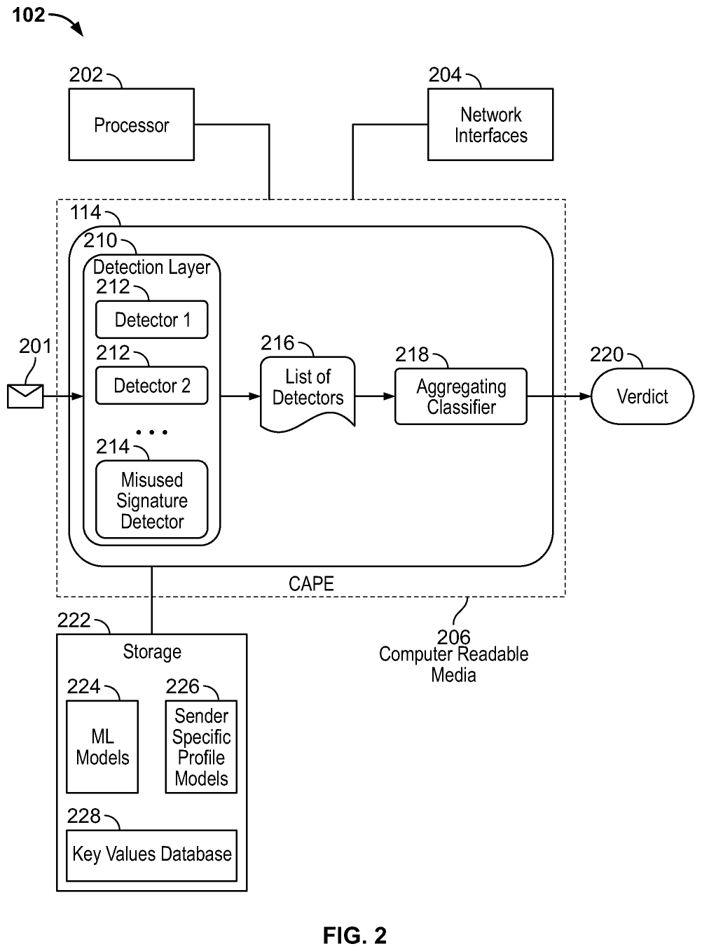

FIG. 2 illustrates a component diagram 200 of an example email-security system 102 that applies a set of sender-specific model models in the CAPE 114 detection system to compute a probability score and classify an email indicating a likelihood of a fraudulent email. As illustrated, the email-security system 102 may include one or more hardware processors 202 (processors), and one or more devices, configured to execute one or more stored instructions. The processor(s) 202 may comprise one or more cores. Further, the email-security system 102 may include one or more network interfaces 204 configured to provide communications between the email-security system 102 and other devices, such as the sending device(s) 104, receiving devices 106, and/or other systems or devices associated with an email service providing the email communications. The network interfaces 204 may include devices configured to couple to personal area networks (PANs), wired and wireless local area networks (LANs), wired and wireless wide area networks (WANs), and so forth. For example, the network interface 204 may include devices compatible with Ethernet, Wi-Fi™, and so forth.

The email-security system 102 may also include computer-readable media 206 that stores various executable components (e.g., software-based components, firmware-based components, etc.). The computer-readable-media 206 may store components to implement the functionality described herein such as components of the CAPE 114 detection process including a set of detectors 210 that include detectors (1, 2 . . . N). In an example embodiment, a misused signature detector 214 may be implemented to detect a signal of an unauthorized sender signature based on one or more extracted email attributes. While not illustrated, the computer-readable media 206 may store one or more operating systems utilized to control the operation of one or more devices that comprise the email-security system 102. According to one embodiment, the operating system comprises the LINUX operating system. According to another embodiment, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 206 may include portions, or components, that configure the email-security system 102 to perform various detection operations described herein. For instance, a detector 212 may be identified from a list of detectors 216 stored in a database (storage 222) configured to, when executed by the processor(s) 202, apply a specific or particular attribute misuse detector to analyze one or more particular email attributes or information to determine a probability score using a sender specific model indicative of fraud or authenticity of an email, the sender, sender closing, display text, or sender signature. In some embodiments, detector 212 may utilize policies or rules to analyze email metadata to determine if the corresponding email is malicious. In some embodiments, the set of detectors 210 (i.e., a detector module) that is configured with one or more select detectors 212 from the list of detectors 216 may be configured to perform various types of security analysis techniques based on applying a series of sender specific models, actions such as determining whether one or more of the following “Display Name” and “From,” “To”, “Cc,” and/or “Bcc” email addresses are associated with legitimate brand names, email addresses, and/or email domains and/or free email service email addresses and/or email domains.

In some embodiments, the computer-readable media 206 may further include a detector 212 that is configured in the email-security system 102 to perform various operations described herein. For instance, the detector 212 may be configured to, when executed by the processor(s) 202, perform various techniques for analyzing particular email information to determine probability scores using sender-specific models indicative of fraud or an authentic email. Detector 212 may utilize policies or rules to analyze email metadata to determine if the corresponding email is malicious. The detector 212 may perform various types of security analysis techniques, such as determining whether the “To” email address(es) are associated with legitimate brand names, email addresses, and/or email domains and/or free email service email addresses and/or email domains.

The computer-readable media 206 may further include a detector 212 for a WHOIS/Certification analysis that configures the email-security system 102 to perform various operations described herein. For instance, the detector 212 for the WHOIS/Certification analysis may be configured to, when executed by the processor(s) 202, perform various techniques for analyzing particular email information to determine probability scores indicative of fraud. The WHOIS/Certification analysis which is performed by detector 212 may include various types of security analysis techniques, such as determining whether one or more of the following “Display Name” and “From,” “To”, “Cc,” and/or “Bcc”, email addresses, are associated with legitimate brand owners via names, email addresses, and/or email domains, cross-referenced against associated WHOIS and/or Certificate information.

The computer-readable media 206 may further include an image analysis by the detector 212 that configures the email-security system 102 to perform various operations described herein. For instance, the image analysis of the detector 212 may be configured to, when executed by the processor(s) 202, perform various techniques for analyzing particular email information to determine probability scores indicative of fraud. The image analysis of detector 212 may utilize policies or rules to analyze email metadata to determine if the corresponding email is malicious. The image analysis of detector 212 may perform various types of security analysis techniques, such as determining whether one or more of the extracted metadata associated with images included in the email are associated with legitimate brand names, email addresses, and/or email domains.

The computer-readable media 206 may further include a final probability and classification by applying one or more user-specific models to compute one or more probability values of attribute misuse that are aggregated by an aggregating classifier component, the probability and classification component 218, that configures the email-security system 102 to perform various operations described herein. For instance, the final probability classification component of the probability and classification component 218 may be configured to, when executed by the processor(s) 202, perform various techniques for averaging the probability scores determined by each user-specific probability model to determine the final probability score indicative of a suspicious or fraudulent email or an authentic email. The probability and classification component 218 in a final probability classification may utilize any one of the different types of averaging including determining a mean, a median, a weighted average, a mode, and/or the like. The probability and classification component 218 may then compare the resulting final probability score (that is an aggregation of values from a combination of computation operations of different user-specific models) to a predetermined threshold value to classify the email as a likelihood of being suspicious, fraudulent, or authentic. As described and alluded to herein, a final probability score exceeding the predetermined threshold value may be indicative of a fraudulent email classification; in other words, exceeding the threshold may not longer classify the email as being simply suspicious requiring a blocking or other more restrictive protective action to be warranted.

In some embodiments, the probability and classification component 218 is configured in a smart layer that combines the attributes into a unique key by the probability and classification component 218 for storing in a key-value database 228 in the cloud that can scale indefinitely in a database (storage 222).

In some embodiments, the probability and classification component 218 operates to aggregate multiple signals and is synchronized with each of the detectors 212. In some embodiments, the probability and classification component 218 enables a verdict 220 based on a threshold value as what is a normal value associated with an email analysis. In embodiments, attributes from multiple emails from email traffic are extracted and normalized in a manner to not reduce latency in traffic flow and to gather a limited subset of information that includes the sender domain, sender address, and sender signature. Hence, the entire email is not extracted but strings of data that can be normalized. The strings may include the recipients' domain, for a global network or domain attributes on a company level. This can enable sender-specific models or models that can be created for existing employees to enable quicker determinations of non-suspicious company emails. In embodiments, profile-specific sender models (i.e., sender-specific models, sender-specific profile models, etc.) that are modeled for an existing company can be imported and used across corporate domains enabling the pooling together of resources amongst groups of companies for email fraud detection.

However, the above-noted list of detectors and components for detecting, aggregating, and classifying extracted attributes of emails and their respective processes are merely exemplary, and other types of security policies may be used to analyze the email metadata. The final probability and classification component 218 may then generate result data indicating a result of the security analysis of the email metadata using one or more policy(ies) that may be stored in storage 222.

Additionally, the service provider network 108 may include storage 222 which may comprise one, or multiple, repositories or other storage locations for persistently storing and managing collections of data such as databases, simple files, binary, and/or any other data. Storage 222 may include one or more storage locations that may be managed by one or more storage/database management systems. In some embodiments, the database configured in storage 222 may be composed of a single database that is written too periodically. In embodiments, the database can be implemented using a sparse array structure for efficient use of memory space and emails can be accorded to separate individual entries in the database.

As illustrated, the storage 222 may include sender-specific models configured with a set of detectors 216 that include attributes such as valid domain(s), ML model(s), saved brand possibilities, impersonated email probabilities, saved sender addresses, saved sender signatures, and saved fraudulent email(s). It should be appreciated that the foregoing list is merely exemplary and the storage 222 may include additional elements that may be apparent to one skilled in the art.

In some embodiments, ML model(s) 224 may be utilized to configure sender-specific models and can be configured with a database of machine learning algorithms included. The ML model(s) may be configured to augment modeled data of the sender-specific models. The ML model(s) may include one or more algorithms including supervised, semi-supervised, unsupervised, and/or reinforcement. In some examples, the processor(s) 202 train(s) the email-security system 102 utilizing machine learning techniques, statistical analysis, or any other means by which a system may be trained to output fraudulent email detection based on input associated with screened email 112 information, established operating parameters from the computer-readable media 206, and/or production data associated with the storage 222.

The saved brand possibilities may include a database of domains found to be associated with legitimate brands. The database may be formed as a historical compilation of legitimate brands found from historical uses of the email-security system 102.

The impersonated email probabilities may store the results and/or timeline of events from the probability and classification component 218. Additionally, the impersonated email probabilities may be a database of historical calculation results. As such, it may be used by the probability and classification component 218 during its operation.

The probability and classification component 218 may, as described and alluded to herein, classify an email as fraudulent by comparison to a threshold value where the probability score is more than the threshold value. In some instances, an email determined to be fraudulent may further be stored in the saved fraudulent email(s) of storage 222.

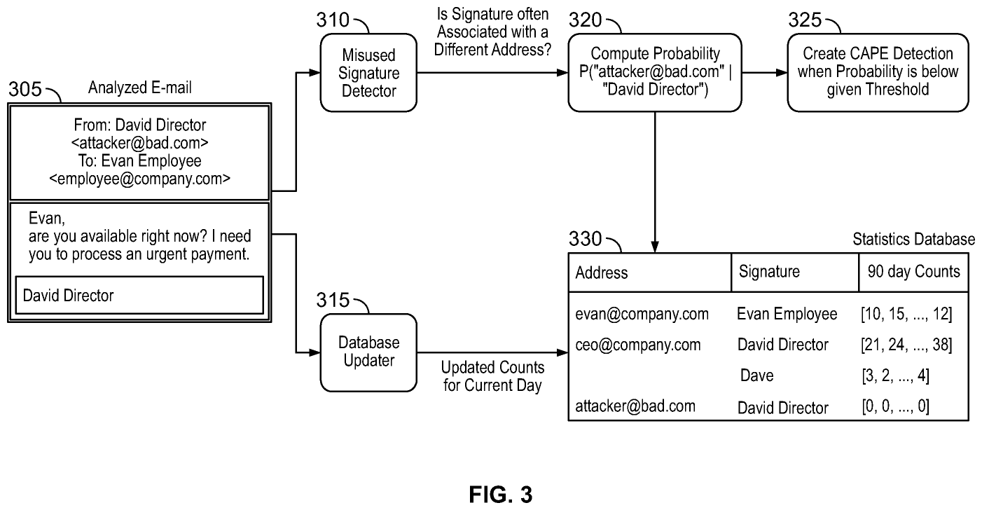

FIG. 3 illustrates a diagram of an example method for an email-security system to detect an email, assign a probability score, and use the probability score to classify the email as an authentic email or a fraudulent email. The email-security system 102 may monitor emails communicated between users of email platforms or services to detect fraudulent emails, phishing emails, and/or other malicious emails.

At 305, the CAPE 114 detection process may analyze a set of attributes directly extracted from email 112 using various attributes extracted from the email. For example, a sender-specific model of a particular detector 212 of the list of detectors 216 identified may perform a from-field analysis (hereinafter referred to as the “FF”) to identify the from-field information of a scanned email 112. The attribute data identified using an identified detector 212 may identify to-field information using text recognition, predetermined field analysis, and the like. One or more of the detectors 212 may be associated with different sender-specific models (sender-specific profile models 226) to compute the likelihood of probabilities of values of misuse of the detected attribute. In some embodiments, one or more detectors 212 may analyze displayed text, the sender email signature, and the email closing of the scanned email 112 using Natural Language Processing (NLP) including contextual-based analysis.

At 310, a misused signature detector is applied identified from a list of detectors to determine whether a signature of email 112 is associated with a different sender email address. This determination is performed via the algorithm at 320 that computes the probability of a sender email address to the signature based on the attributes detected from the email 112. This determination is based in part on record data in record database 330 that contains a statistical database record for a sender-specific model composed of individual sender email addresses associated with a sender signature and a computed count for a select period (in this exemplary case 90 days) of its association.

At 325, if CAPE 114 determines that the value of the computed overall probability value is less than a threshold probability value, a verdict or classifying of the email is made that the email is likely deemed suspicious or not.

At 315, in an alternate parallel process flow, a count of the attribute data is updated in the record database for use with each specific sender model. The count data includes updated counts for select periods such as daily updates, and timestamps of detections of a sender address associated with a sender signature. This results in an updated sender-specific model for each sender and a count updated of the sender address associated with the sender signature.

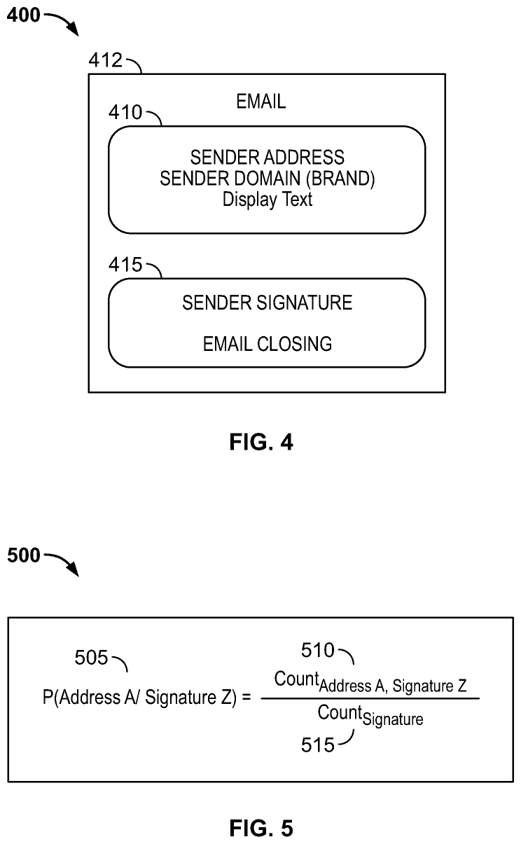

FIG. 4 is an exemplary set of attributes from an email that may be extracted for use in detection and for updating the statistical data in each sender-specific model that computes a probability value to determine whether the email is suspicious or not.

The scanned email 112 of FIG. 4 may include directly and indirectly extracted information for use by CAPE 114 of the email security system 102 to update statistical records for sender-specific models in storage 222. In some embodiments, a direct set of extracted data may be gleaned from attribute data detected by the set of detectors 216 that includes attributes 410. These attributes 410 include meta detected to determine a display name from the scanned email 112. For example, a detected portion of the scanned email 112 detailing the display name associated with the scanned email 112. In some other instances, a detector 212 may use textual recognition to determine the display name from a field of the scanned email 112.

Detector 212 may determine whether the display name is a person or not. For example, may compare the display name to a look-up table of names contained within the storage 222. In some other instances, detector 212 may utilize ML model(s) 224 to determine whether the display name is a person or not. In some further instances, detector 212 may compare the display name to the saved brand possibilities stored in the database sender-specific models 226 where matches may indicate that the display name is not a person.

Another set of attributes 415 may include a sender signature and email closing. In some embodiments, a detector 212 or set of detectors 210 may recognize images contained within the screened email 112 or may determine the text (txt) contained within the image files. In some instances, via image analysis, the detector may perform an image analysis to determine an organization (i.e., brand) name(s) contained within the image. The detectors 210 may use textual recognition to determine text associated with organization names. In other instances, the detectors 212 may compare the image file text to the valid domains, the ML model(s), and/or the saved brand possibilities contained within storage 222. In some further instances,

In some embodiments, the detectors 212 may determine whether an organization was found within the image file text. For example, detectors 212 may apply one or more sender-specific models to match an organization name found within the image file text with an organization name from one or more records in storage 222.

In some embodiments, the detectors 212 may determine necessary sender model data (i.e., attributes of the sender) from an address domain or may apply one or more sender-specific models directed to a portion of the scanned email 112 detailing the display name associated with the scanned email 112. In some other instances, the detectors 212 may use textual recognition to determine the display name from a field of the scanned email 112.

In some embodiments, one or more probabilities determined using the aggregating classifier (probability and classification component 218) may compare the determined address domain, to determine a likelihood of whether the from-field domain address matches any free email service domains or not. For example, one or more counts of detection associated with probabilities from detections derived from applications of sender-specific models may determine the authenticity of whether an address domain is from@realbrand.com; for example, determine a probability that the domain (i.e., “@realbrand.com”) does not match any corporate email service domains.

FIG. 5 illustrates an exemplary algorithm of a sender-specific model that estimates a conditional signature of the CAPE in the email security system 102 according to some embodiments. Algorithm 500 is applied to attributes (for the sender-specific models) extracted from an email and in runtime queries of the database records in the storage 222 to retrieve observation count data 510 of sender addresses and sender signatures to compare against counts of sender signatures 515 of a sender-specific model to generate conditional probabilities values 505. The conditional probabilities are used as estimates of the likelihood of authenticity or misuse of a sender address to the sender's signature. The probability value for each aggregate set of detections for a set of sender-specific models is weighed against one or more thresholds to discover rare senders, rare sender domains, or a misused sender name and signature (i.e., an impersonation or fraud email). Based on the confidence level, which is associated with an applicable threshold, the detection can present a verdict to convey an action such as tagging an email with a warning or generating an alert for an email. Other actions can be configured such as informing the recipient that the email is authentic, not blocking the email, and using the result determined to update data associated with a sender-specific model. For example, the sender-specific model can be modeled using email headers and content based on probability value decisions. In some embodiments, the statistics or probabilities that are generated per detection can be stored in a database of the storage 222 that may be configured locally or can be globally accessible throughout a network per a customer or group of customers. In some embodiments, the classifying of emails based on signals from one or more detections of an email are aggregated to determine overall probabilities associated with an email 112 and these results may be used as filters or contextual-based detectors that can predict that a sender is unusual to a recipient address (i.e., a suspicious email) without requiring clear malicious signals associated with a particular email.

In some embodiments, the overall probability value (or score) that is determined by the CAPE 114 of the email security system 102 may be indicative of an impersonated email probability indicating that the email is fraudulent. In some embodiments, the overall probability value may be indicative that one or more attributes of the email are misused, or the behavior of the sender is fraudulent or suspicious.

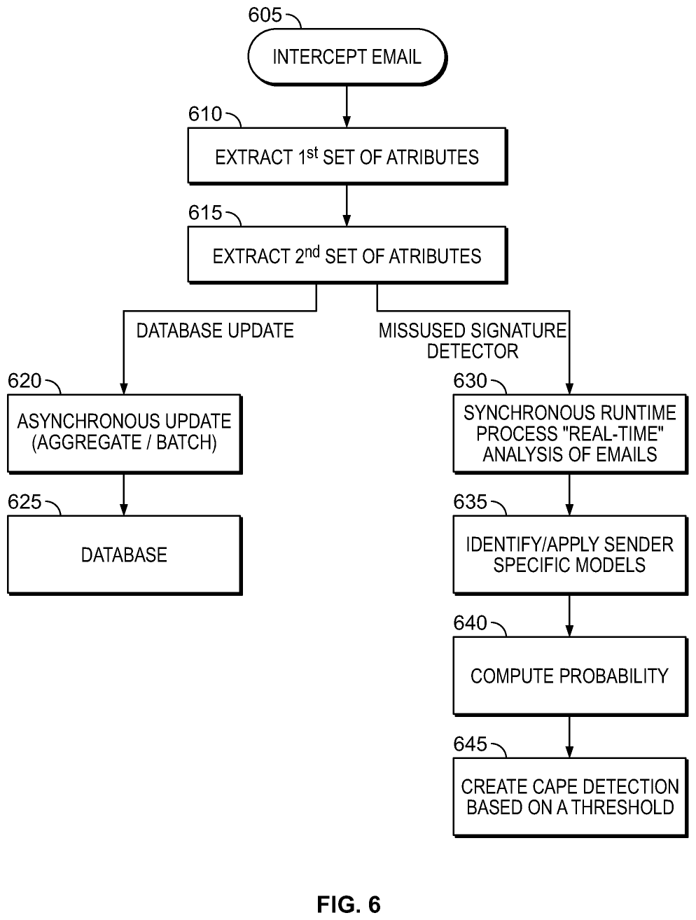

FIG. 6 illustrates a flow diagram of an example method 600 that illustrates aspects of the functions performed at least partly by the devices in the computing infrastructures as described in FIGS. 1-5. The logical operations described herein with respect to FIG. 6 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special-purpose digital logic, and any combination thereof. It should also be appreciated that more or fewer operations might be performed than shown in FIG. 6 and described herein. These operations can also be performed in parallel, or a different order than those described herein. Some or all of these operations can also be performed by components other than those specifically identified. Although the techniques described in this disclosure with reference to specific components, in other examples, the techniques may be implemented by fewer components, more components, and/or different components.

FIG. 6 illustrates a flow diagram of an example method for an email-security system to screen emails, analyze their contents, and assign a probability score and classification indicative of a probability that the screened email 112 is fraudulent or not. The techniques may be applied by a system comprising one or more processors, and one or more non-transitory computer-readable media storing computer-executable instructions that, when executed by one or more processors, cause one or more processors to perform operations of method 600.

At 605, an email-security system 102 may receive an email sent from a sending email address (i.e., sending device) and to a targeted email address (i.e., receiving device). For instance, the email-security system 102 may monitor emails communicated by an email service platform and obtain the email. The email-security system 102 may classify email 110 as a screened email 112. For example, the processor(s) 202 may classify incoming emails 110 as screened and initiate a process of analyzing them for fraud.

At 610, the email-security system 102 may extract information from the screened email 112. For example, the set of detectors 212 configured in a detection layer may extract a first set of attributes that consists of direct information from email 112 about the sender for determining a probability of misuse by a sender-specific model which includes the sender address, sender domain, and displayed text.

At 615, the email security system 102 may extract indirect contextual information of a second set of attributes about the sender's behavior for determining probability values of misuse by the sender-specific model which may include data of the sender signature and the email closing.

At 620, the database for storing email sender-specific models may be updated with counts of attributes detected in received emails by the email security system 102. The updates may be performed asynchronously to a database at storage 222 by an aggregate or batch operation of multiple sets of attribute data.

At 625, the attribute data in the updates which includes directly and indirectly extracted attribute data for one or more user-specific models are stored in a sparse array that stores configured individual records of sender-specific model data in the database. For example, the updated data to the database may include updates of observed counts detected by one or more detectors in a list of detectors 210 identified by the CAPE 114 of the email security system 102.

At 630, in the parallel process flow, a synchronous runtime operation is executed by the CAPE 114 of the email security system 102 to detect using one or more detectors identified in a list of detectors 216 that is stored in the database of the storage 222.

At 635, one or more user-specific models are applied by the detector to determine the misuse of attribute data that is composed of a first set of directly extracted attribute data and a second set of indirectly attributed data. In some embodiments, the second set of indirect attribute data is gleaned by textual image processing or natural language processing. The second set of attribute data can be used to determine context-based sender behavior.

At 640, one or more probabilities, using the sender-specific models for each extracted attribute of the email, are computed of the likelihood associated with misuse of the particular detected attribute from the email.

At 645, a verdict is determined based on the CAPE 114 computations of an overall probability value that is compared to a threshold that determines whether the email is suspicious or not. For instance, a predetermined threshold value (i.e., score) may be contained within the impersonated email probabilities. As such, a determined probability score over the predetermined threshold value may be indicative of a fraudulent email. For example, the email-security system 102 may determine, a probability score for the screened email 112 of “0.9.” Furthermore, a predetermined threshold score may be “0.75.” As such, the probability score of the screened email 112 would exceed the threshold score, and the email-security system 102 may classify, based at least in part on the probability score, that the screened email 112 is fraudulent, suspicious, or not.

The email-security system 102 may allow, based at least in part on a non-fraudulent classification, the screened email 112 to pass the email-security system 102 as an allowed email 110. As such, the allowed email 110 may be allowed to pass between the sending device(s) 104 and the receiving device(s) 106, along the network(s) 108, freely.

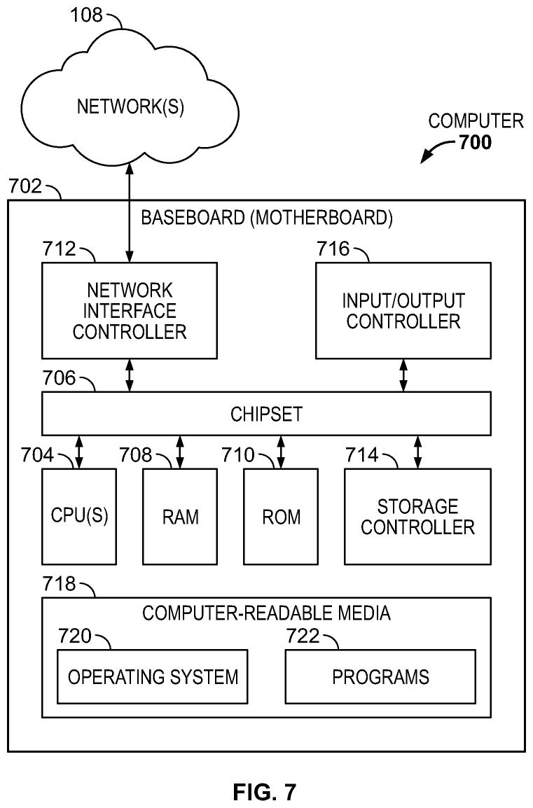

FIG. 7 shows an example of computer architecture for a computer 700 capable of executing program components for implementing the functionality described above. The computer architecture is shown in FIG. 7 illustrates a conventional server computer, workstation, desktop computer, laptop, tablet, network appliance, e-reader, smartphone, or other computing device, and can be utilized to execute any of the software components presented herein. The Computer 700 may, in some examples, correspond to a physical server that is included in the email security system 102 described herein, and may comprise networked devices such as servers, switches, routers, hubs, bridges, gateways, modems, repeaters, access points, etc.

The Computer 700 includes a baseboard 702, or “motherboard,” which is a printed circuit board to which a multitude of components or devices can be connected by way of a system bus or other electrical communication paths. In one illustrative configuration, one or more central processing units (“CPUs”) 704 operate in conjunction with a chipset 706. The CPU 704 can be a standard programmable processor that performs arithmetic and logical operations necessary for the operation of the Computer 700.

The CPUs 704 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 706 provides an interface between the CPU 704 and the remainder of the components and devices on the baseboard 702. The chipset 706 can provide an interface to a RAM 708, used as the main memory in the computer 700. The chipset 706 can further provide an interface to a computer-readable storage medium such as read-only memory (“ROM”) 710 or non-volatile RAM (“NVRAM”) for storing basic routines that help to startup the computer 700 and to transfer information between the various components and devices. The ROM 710 or NVRAM can also store other software components necessary for the operation of the Computer 700 in accordance with the configurations described herein.

The Computer 700 can operate in a networked environment using logical connections to remote computing devices and computer systems through a network, such as Network 108. The chipset 706 can include functionality for providing network connectivity through a NIC 712, such as a gigabit Ethernet adapter. The NIC 712 is capable of connecting the Computer 700 to other computing devices over network 108. It should be appreciated that multiple NICs 712 can be present in computer 700, connecting the computer to other types of networks and remote computer systems.

The Computer 700 can be connected to a storage device 718 that provides non-volatile storage for the computer. The storage device 718 can store an operating system 720, programs 722, and data, which have been described in greater detail herein. The storage device 718 can be connected to the computer 700 through a storage controller 714 connected to the chipset 706. The storage device 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other types of interface for physically connecting and transferring data between computers and physical storage units.

The Computer 700 can store data on the storage device 718 by transforming the physical state of the physical storage units to reflect the information being stored. The specific transformation of the physical state can depend on various factors, in different embodiments of this description. Examples of such factors can include but are not limited to, the technology used to implement the physical storage units, whether the storage device 718 is characterized as primary or secondary storage, and the like.

For example, computer 700 can store information to the storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete components in a solid-state storage unit. Other transformations of physical media are possible without departing from the scope and spirit of the present description, with the foregoing examples provided only to facilitate this description. The Computer 700 can further read information from storage device 718 by detecting the physical states or characteristics of one or more locations within the physical storage units.

In addition to the mass storage device 718 described above, the computer 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 700. In some examples, the operations performed by devices in a distributed application architecture, and or any components included therein, may be supported by one or more devices similar to Computer 700. Stated otherwise, some or all of the operations performed by the email-security system 102, and or any components included therein, may be performed by one or more computers 700 (i.e., computer devices) operating in any system or arrangement.

By way of example, and not limitation, computer-readable storage media can include volatile and non-volatile, removable, and non-removable media implemented in any method or technology. Computer-readable storage media includes but is not limited to, RAM, ROM, erasable programmable ROM (“EPROM”), electrically-erasable programmable ROM (“EEPROM”), flash memory, or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 718 can store an operating system 720 utilized to control the operation of the computer 700. According to one embodiment, the operating system comprises the LINUX operating system. According to another embodiment, the operating system comprises the WINDOWS® SERVER operating system from MICROSOFT® Corporation of Redmond, Washington. According to further embodiments, the operating system can comprise the UNIX operating system or one of its variants. It should be appreciated that other operating systems can also be utilized. The storage device 718 can store other system or application programs and data utilized by the computer 700.

In one embodiment, the storage device 718 or other computer-readable storage media is encoded with computer-executable instructions which, when loaded into the computer 700, transform the computer from a general-purpose computing system into a special-purpose computer capable of implementing the embodiments described herein. These computer-executable instructions transform the computer 700 by specifying how the CPUs 704 transition between states, as described above. According to one embodiment, the computer 700 has access to computer-readable storage media storing computer-executable instructions which, when executed by the computer 700, perform the various processes described above with regard to FIGS. 1-6. The Computer 700 can also include computer-readable storage media having instructions stored thereupon for performing any of the other computer-implemented operations described herein.

The computer 700 can also include one or more input/output controllers 716 for receiving and processing input from a number of input devices, such as a keyboard, a mouse, a touchpad, a touch screen, an electronic stylus, or other types of input devices. Similarly, an input/output controller 716 can provide output to a display, such as a computer monitor, a flat-panel display, a digital projector, a printer, or other type of output device. It will be appreciated that the computer 700 might not include all of the components shown in FIG. 7, can include other components that are not explicitly shown in FIG. 7, or might utilize an architecture completely different than that shown in FIG. 7.

In some aspects, the techniques described herein relate to a method including: analyzing an email sent from a sending device sent to a receiving device; extracting at least a first sender attribute and a second sender attribute from the email; identifying one or more sender-specific models associated with the sending device; applying the one or more sender-specific models to determine a first probability value associated with the first sender attribute that conveys a likelihood that the first sender attribute is a misused sender attribute; applying the one or more sender-specific models to determine a second probability value associated with the second sender attribute is a second misused sender attribute; and determining, by using the first probability value and the second probability value, an overall probability value associated with a likelihood of classifying the email as at least one of a suspicious email or not.

In some aspects, the techniques described herein relate to a method, further including: assigning an action based on classifying the email to the receiving device indicating at least one of indicating the email is suspicious, preventing delivery of the email, or authorizing delivery of the email.

In some aspects, the techniques described herein relate to a method, further including: identifying one or more detectors for detecting data of the first sender attribute; and using data detected of the first sender attribute for computing the first probability value by the one or more sender-specific models that convey the likelihood that the first sender attribute is misused.

In some aspects, the techniques described herein relate to a method, further including: identifying one or more detectors for detecting data of the second sender attribute; and using data detected of the second sender attribute for computing the second probability value by the one or more sender-specific models that convey the likelihood that the second sender attribute is misused.

In some aspects, the techniques described herein relate to a method, further including: extracting the first sender attribute that includes at least one of a sender domain, a sender address, or a displayed text for one or more sender-specific models.

In some aspects, the techniques described herein relate to a method, further including: extracting the second sender attribute that includes at least one of a sender's signatures or an email closing from the content of the email using a Natural Language Processing (NPL) process for the one or more sender-specific models.

In some aspects, the techniques described herein relate to a method, further including determining by applying one or more sender-specific models the likelihood of a first misuse sender attribute for computing a conditional probability based on the detection of the first sender attribute from an email and probability data stored in a database.

In some aspects, the techniques described herein relate to a method, further including determining by applying one or more sender-specific models the likelihood of a second misuse sender attribute for computing a conditional probability based on the detection of the second sender attribute from email and probability data stored in a database.

In some aspects, the techniques described herein relate to a system including: one or more processors; and one or more non-transitory computer-readable media storing computer-executable instructions that, when executed by the one or more processors, cause the one or more processor to perform operations including: analyzing an email sent from a sending device sent to a receiving device; extracting at least a first sender attribute and a second sender attribute from the email; identifying one or more sender-specific models associated with the sending device; applying the one or more sender-specific models to determine a first probability value associated with the first sender attribute that conveys a likelihood that the first sender attribute is a misused sender attribute; applying the one or more sender-specific models to determine a second probability value associated with the second sender attribute is a second misused sender attribute; and determining, by using the first probability value and the second probability value, an overall probability value associated with a likelihood for classifying the email as at least one of a suspicious email or not.

In some aspects, the techniques described herein relate to a system, wherein one or more processors are configured to perform operations further including: assigning an action based on classifying the email to the receiving device indicating including at least one indicating the email is suspicious, preventing delivery of the email, or authorizing delivery of the email.

In some aspects, the techniques described herein relate to a system, wherein one or more processors are configured to perform operations further including identifying one or more detectors for detecting data of the first sender attribute; and using data detected of the first sender attribute for computing the first probability value by one or more sender-specific models that conveys the likelihood that the first sender attribute is misused.

In some aspects, the techniques described herein relate to a system, wherein one or more processors are configured to perform operations further including identifying one or more detectors for detecting data of the second sender attribute; and using data detected of the second sender attribute for computing the second probability value by the one or more sender-specific models that convey the likelihood that the second sender attribute is misused.

In some aspects, the techniques described herein relate to a system, wherein one or more processors are configured to perform operations further including extracting the first sender attribute that includes at least one of a sender domain, a sender address, or a displayed text for the one or more sender-specific models.

In some aspects, the techniques described herein relate to a system, wherein one or more processors are configured to perform operations further including extracting the second sender attribute that includes at least one of a sender's signatures or an email closing from the content of the email using a Natural Language Processing (NPL) process for the one or more sender-specific models.

In some aspects, the techniques described herein relate to a system, wherein one or more processors are configured to perform operations further including determining by applying one or more sender-specific models the likelihood of a first misuse sender attribute for computing a conditional probability based on detection of the first sender attribute from an email and probability data stored in a database.

In some aspects, the techniques described herein relate to a system, wherein one or more processors are configured to perform operations further including determining by applying one or more sender-specific models the likelihood of a second misuse sender attribute for computing a conditional probability based on detection of the second sender attribute from email and probability data stored in a database.

In some aspects, the techniques described herein relate to one or more non-transitory computer-readable media storing computer-executable instructions that, when executed by one or more processors, cause the one or more processors to perform operations including analyzing an email sent from a sending device sent to a receiving device; extracting at least a first sender attribute and a second sender attribute from the email; identifying one or more sender-specific models associated with the sending device; applying the one or more sender-specific models to determine a first probability value associated with the first sender attribute that conveys a likelihood that the first sender attribute is a misused sender attribute; applying the one or more sender-specific models to determine a second probability value associated with the second sender attribute is a second misused sender attribute; and determining, by using the first probability value and the second probability value, an overall probability value associated with a likelihood for classifying the email as at least one of a suspicious email or not.

In some aspects, the techniques described herein relate to one or more non-transitory computer-readable media, further including assigning an action based on classifying the email to the receiving device indicating including at least one of indicating the email is suspicious, preventing delivery of the email, or authorizing delivery of the email.

In some aspects, the techniques described herein relate to one or more non-transitory computer-readable media, further including: identifying one or more detectors for detecting data of the first sender attribute; and using data detected of the first sender attribute for computing the first probability value by the one or more user-specific models that convey the likelihood that the first sender attribute is misused.

In some aspects, the techniques described herein relate to one or more non-transitory computer-readable media, further including: identifying one or more detectors for detecting data of the second sender attribute; and using data detected of the second sender attribute for computing the second probability value by the one or more sender-specific models that convey the likelihood that the second sender attribute is misused.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed is:

1. A method comprising:
analyzing an email sent from a sending device sent to a receiving device;
extracting at least a first sender attribute and a second sender attribute from the email;
identifying one or more sender-specific models associated with the sending device;
applying the one or more sender-specific models to determine a first probability value associated with the first sender attribute that conveys a likelihood that the first sender attribute is a misused sender attribute;
applying the one or more sender-specific models to determine a second probability value associated with the second sender attribute is a second misused sender attribute; and
determining, by using the first probability value and the second probability value, an overall probability value associated with a likelihood of classifying the email as at least one of a suspicious email or not.

2. The method of claim 1, further comprising:
assigning an action based on classifying of the email to the receiving device indicating comprising at least one of indicating the email is suspicious, preventing delivery of the email, or authorizing delivery of the email.

3. The method of claim 1, further comprising:
identifying one or more detectors for detecting data of the first sender attribute; and
using data detected of the first sender attribute for computing the first probability value by the one or more sender-specific models that convey the likelihood that the first sender attribute is misused.

4. The method of claim 1, further comprising:
identifying one or more detectors for detecting data of the second sender attribute; and
using data detected of the second sender attribute for computing the second probability value by the one or more sender-specific models that convey the likelihood that the second sender attribute is misused.

5. The method of claim 4, further comprising:
extracting the first sender attribute that comprises at least one of a sender domain, a sender address, or a displayed text for the one or more sender-specific models.

6. The method of claim 1, further comprising:
extracting the second sender attribute that comprises at least one of a sender signature or an email closing from content of the email using a Natural Language Processing (NPL) process for the one or more sender-specific models.

7. The method of claim 6, further comprising:
determining by applying one or more sender-specific models the likelihood of a first misuse sender attribute for computing a conditional probability based on detection of the first sender attribute from an email and probability data stored in a database.

8. The method of claim 7, further comprising:
determining by applying one or more sender-specific models the likelihood of a second misuse sender attribute for computing a conditional probability based on detection of the second sender attribute from email and probability data stored in a database.

9. A system comprising:
one or more processors; and
one or more non-transitory computer-readable media storing computer-executable instructions that, when executed by the one or more processors, cause the one or more processors to perform operations comprising:
analyzing an email sent from a sending device sent to a receiving device;
extracting at least a first sender attribute and a second sender attribute from the email;
identifying one or more sender-specific models associated with the sending device;
applying the one or more sender-specific models to determine a first probability value associated with the first sender attribute that conveys a likelihood that the first sender attribute is a misused sender attribute;
applying the one or more sender-specific models to determine a second probability value associated with the second sender attribute is a second misused sender attribute; and
determining, by using the first probability value and the second probability value, an overall probability value associated with a likelihood for classifying the email as at least one of a suspicious email or not.

10. The system of claim 9, wherein the one or more processors configured to perform operations further comprising:
assigning an action based on classifying of the email to the receiving device indicating comprising at least one of indicating the email is suspicious, preventing delivery of the email, or authorizing delivery of the email.

11. The system of claim 9, wherein the one or more processors configured to perform operations further comprising:
identifying one or more detectors for detecting data of the first sender attribute; and
using data detected of the first sender attribute for computing the first probability value by one or more sender-specific models that conveys the likelihood that the first sender attribute is misused.

12. The system of claim 9, wherein the one or more processors configured to perform operations further comprising:
identifying one or more detectors for detecting data of the second sender attribute; and
using data detected of the second sender attribute for computing the second probability value by the one or more sender-specific models that convey the likelihood that the second sender attribute is misused.

13. The system of claim 11, wherein the one or more processors configured to perform operations further comprising:
extracting the first sender attribute that comprises at least one of a sender domain, a sender address, or a displayed text for the one or more sender-specific models.

14. The system of claim 12, wherein the one or more processors configured to perform operations further comprising:
extracting the second sender attribute that comprises at least one of a sender signature or an email closing from content of the email using a Natural Language Processing (NPL) process for the one or more sender-specific models.

15. The system of claim 14, wherein the one or more processors configured to perform operations further comprising:
determining by applying one or more sender-specific models the likelihood of a first misuse sender attribute for computing a conditional probability based on detection of the first sender attribute from an email and probability data stored in a database.

16. The system of claim 15, wherein the one or more processors configured to perform operations further comprising:
determining by applying one or more sender-specific models the likelihood of a second misuse sender attribute for computing a conditional probability based on detection of the second sender attribute from email and probability data stored in a database.

17. One or more non-transitory computer-readable media storing computer-executable instructions that, when executed by one or more processors, cause the one or more processors to perform operations comprising:
analyzing an email sent from a sending device sent to a receiving device;
extracting at least a first sender attribute and a second sender attribute from the email;
identifying one or more sender-specific models associated with the sending device;
applying the one or more sender-specific models to determine a first probability value associated with the first sender attribute that conveys a likelihood that the first sender attribute is a misused sender attribute;
applying the one or more sender-specific models to determine a second probability value associated with the second sender attribute is a second misused sender attribute; and
determining, by using the first probability value and the second probability value, an overall probability value associated with a likelihood for classifying the email as at least one of a suspicious email or not.

18. The one or more non-transitory computer-readable media of claim 17, further including:
assigning an action based on classifying of the email to the receiving device indicating comprising at least one of indicating the email is suspicious, preventing delivery of the email, or authorizing delivery of the email.

19. The one or more non-transitory computer-readable media of claim 18, further including:
identifying one or more detectors for detecting data of the first sender attribute; and
using data detected of the first sender attribute for computing the first probability value by the one or more sender-specific models that convey the likelihood that the first sender attribute is misused.

20. The one or more non-transitory computer-readable media of claim 17, further including:
identifying one or more detectors for detecting data of the second sender attribute; and
using data detected of the second sender attribute for computing the second probability value by the one or more sender-specific models that convey the likelihood that the second sender attribute is misused.
